(19) United States
(12) Patent Application Publication
(10) Pub. No.: US 2026/0095521 A1
(43) Pub. Date: Apr. 2, 2026

(54) COMPANION MODULE HAVING ARTIFICIAL INTELLIGENCE

(71) Applicant: Lenovo (United States) Inc., Morrisville, NC (US)

(72) Inventors: Madison Smith, Santa Rosa, CA (US); Xinhuan Chen, Cary, NC (US); Cuong Truong, Cary, NC (US)

(21) Appl. No.: 18/902,353

(22) Filed: Sep. 30, 2024

(51) Int. Cl. H04M 1/72409; G06F 1/16; G06F 3/16; H04M 1/02; H04M 1/72454; H04M 1/72457

(52) U.S. Cl. CPC H04M 1/72409; G06F 1/1626; G06F 1/163; G06F 3/16; H04M 1/0264; H04M 1/0266; H04M 1/0274; H04M 1/72454; H04M 1/72457

(57) ABSTRACT

One embodiment provides a device, the device including: a module having two sides, wherein the two sides are opposite each other, the module including: at least one display screen located on at least one of the two sides of the module; at least one image capture device located on at least one of the two sides of the module; at least one processor; and at least one memory device storing program code for an artificial intelligence system; wherein the module communicates with an information handling device; and wherein the module performs functions utilizing the at least one processor and the artificial intelligence system. Other aspects are claimed and described.

### BACKGROUND

Artificial intelligence (AI) is becoming more sophisticated to the point of allowing base AI models or systems to be utilized as a starting point to make AI models or systems that are unique to specific entities, groups, users, and/or the like. In other words, AI is developing such that AI models can be made to be unique to a particular entity, group, user, and/or the like, whereas years ago it would be too resource intensive to make AI models such as these. Generally, these unique models all start as a single base model. In other words, a single trained model can be utilized as the starting model or default model and then modified to be unique to the target entity, group, user, and/or the like.

The model is then deployed on devices that can capture information related to the target entity, group, user, and/or the like. Additionally, the model could be provided with some information that is related to the target entity, group, user, and/or the like. As this information is ingested by the model, either from devices, as supplied by an entity, or any other technique for providing information to the model, the model's training is refined and modified to incorporate this information. Thus, predictions made by the retrained model are based upon the information unique to the target entity, group, user, and/or the like, and the predictions reflect the unique information. Accordingly, over time, the predictions and outputs provided by the model become unique to the target entity, group, user, and/or the like.

### BRIEF SUMMARY

In summary, one aspect provides a device, the device including: a module having two sides, wherein the two sides are opposite each other, the module including: at least one display screen located on at least one of the two sides of the module; at least one image capture device located on at least one of the two sides of the module; at least one processor; and at least one memory device storing program code for an artificial intelligence system; wherein the module communicates with an information handling device; and wherein the module performs functions utilizing the at least one processor and the artificial intelligence system.

Another aspect provides a system, the system including: an information handling device; a module having two sides, wherein the two sides are opposite each other, the module including: at least one display screen located on at least one of the two sides of the module; at least one image capture device located on at least one of the two sides of the module; at least one processor; and at least one memory device storing program code for an artificial intelligence system; wherein the module communicates with the information handling device; and wherein the module performs functions utilizing the at least one processor and the artificial intelligence system.

A further aspect provides a method, the method including: receiving, at a module having two sides, information related to a user and a context of the user, wherein the two sides are opposite each other, wherein the module includes at least one display screen located on at least one of the two sides of the module and at least one image capture device located on at least one of the two sides of the module, wherein the module communicates with an information handling device; identifying a function to be performed to assist the user by analyzing, using an artificial intelligence system of the module, the information; and performing, using the module, the function.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for performing functions utilizing a device companion module having an artificial intelligence system based upon information received by the module and related to a user.

FIG. 4A illustrates an example side of the module having a display.

FIG. 4B illustrates an example side of the module having an image capture device.

FIG. 5 illustrates an example of a module that is attachable to an information handling device and the attachment of the module to the information handling device.

FIG. 6 illustrates examples of a module connected to different information handling devices.

FIG. 7 illustrates examples of a module connected to a wearable accessory.

### DETAILED DESCRIPTION

With the development of artificial intelligence (AI) models and systems that can be unique to a particular entity (e.g., company, group, department, user, etc.), more and more devices are either utilizing AI models to become unique to a user or devices are being developed to specifically use such models and systems. These systems and devices that are utilizing these AI models and systems are desirable to users because the outputs or responses by these systems and devices are specific to the user. As a simple example, the device can respond to a user using the user's name, whereas devices and systems which do not use such technology would either use a generic term to refer to the user or not use an identifier at all. Since AI models and systems can be very complex, the utilization of such AI models and systems in devices can result in very personalized outputs that are helpful to a user. For example, a device having an AI model and system can be used by a user as a digital assistant that can provide schedule reminders, make recommendations for the user based upon user preferences and habits, and/or the like.

However, most of these devices are limited in what inputs or information can be captured and provided to the AI model or system. For example, many of the devices may be relatively stationary with respect to movements of the user. For example, even though a laptop computer could capture many different inputs or information, a user is not going to carry a laptop everywhere and, even when the user carries the laptop, it is likely not in a state that can be utilized to capture inputs and information. In other words, the cover of the laptop is most likely closed which negates the ability to capture information using an image capture device and other sensors. This is particularly true when the laptop is in a sleep or reduced power state and many components or sensors are turned off to conserve power.

Additionally, the components that are utilized for capturing the inputs, for example, image capture devices, microphones, proximity sensors, other components, other sensors, and/or the like, are located at a fixed position on the device. For example, an image capture device on a laptop, tablet, smart phone, and/or the like, are located at a fixed position on the information handling device and can only capture information within the field of view of the image capture device. Accordingly, any information or inputs that could be useful but that is not located within the field of view is not captured and is, therefore, not usable by the AI system. Additionally, while many devices are portable and are likely carried by the user, the form factor may not lend itself to the ability to capture all types of inputs, for example, in the case of a smart watch, fitness tracker, and/or the like, or is not likely to be carried in a manner that would allow for capturing of useful information, for example, in the case of a smart phone, tablet, and/or the like.

Additionally, the device may be limited in what outputs can be provided to a user. For example, devices that only have a display screen can only provide visual outputs. As another example, some devices do not have speakers to provide audio output. Additionally, the way that a device would be carried would influence the usability of the device for providing outputs to the user. For example, while a user may carry a smart phone with them, while they are walking, this phone may be in a pocket, bag, purse, and/or the like. This means that any outputs provided by the phone may not be viewable, audible, or otherwise noticeable or useful to a user. Thus, while personalized AI models and systems may be helpful to a user, the full potential of these models and systems is not possible with current devices because they do not provide an ability to continuously capture information about a user that would make them more personalize to the user. Additionally, current devices are limited in how outputs can be provided to user based upon form factors and how the devices are utilized.

Accordingly, the described system and method provides a device and system for a module that acts as a companion device to other devices of a user and that utilizes an artificial intelligence (AI) system to perform functions for a user. The functions can be outputs to the user, outputs to a device, and/or the like. Additionally, the described system and method provides a technique for performing functions utilizing a device companion module having an artificial intelligence system based upon information received by the module and related to a user. The module has two opposing sides. One side may include a display for visually displaying outputs. One side, which may be the same or the opposite side, may include an image capture device for capturing visual information. The module may also include a processor and memory device. The memory device may include program code for an artificial intelligence system that is utilized by the module to perform functions. The functions may include functions to provide output to a user of the module or may include functions that provide output or instructions to other devices with which the module can communicate. The functions that can be performed by the module may vary based upon the location of the module with respect to different devices or accessories.

The module may communicate with an information handling device. The module may be attachable to the information handling device or may be integral to the information handling device. The module may be attachable to or integral to many different information handling devices, for example, any device that may be associated with a particular user, and/or the like. Thus, the module may be attachable to laptop devices, personal computing devices, displays, tablets, smart phones, smart appliances, wearable accessories, accessory extensions, and/or the like. Additionally, the module can communicate with any of these devices and may also communicate with any other devices such as, for example, devices within an Internet of Things (IoT) setting, smart home devices, devices within an environment of the user, devices of other users, earbuds, keyboards, input devices, and/or the like.

Additionally, the module could be attached to, located within, or integral to accessories that are designed for holding the module. For example, the module could be attached to wearable accessories, for example, a watch band, necklace, pendant, belt buckle, shoe buckle, and/or the like. These wearable accessories would allow the module to be worn by the user without having to hold the module, thereby allowing the module to capture information and inputs as the user is moving throughout their environment. The module could also have a pod module that would provide the module with additional functionality. The pod module may provide for charging capabilities and battery extension when the module is not attached to an information handling device, may allow the module to act as a conference speaker, may allow the module to interact with smart home devices, and/or the like. The pod module may allow the user a place to put the module that is not connected to an information handling device but is stationary within an environment that still allows for live communication to an information handling device via near-field wireless communications, short-range wireless communications, network wireless communication, or any other remote communication capabilities.

Therefore, a system provides a technical improvement over traditional devices and methods for personalized devices. The described module and corresponding accessories are designed to allow for easy transportation of the module, thereby allowing the module to capture information and inputs as a user moves throughout an environment. Unlike traditional devices which may only capture information within a single space or field of view, the described module can be attached to different devices or accessories that allow the device to capture information as the user would capture information. This information and inputs can be provided to the artificial intelligence system of the module so that it can be refined to become very unique and personalized to the user. Additionally, due to the form factor, on-board components, and ability to communicate with other devices, the module is able to capture all types of inputs and provide all types of outputs to perform functions that are desired by or otherwise useful to the user. Accordingly, the described device, system, and method provides a more complete personalized AI experience for a user and is also able to perform functions that are not possible using conventional devices or systems in many different environments that may not be accessible to a single traditional device.

The illustrated example embodiments will be best understood by reference to the figures. The following description is intended only by way of example, and simply illustrates certain example embodiments.

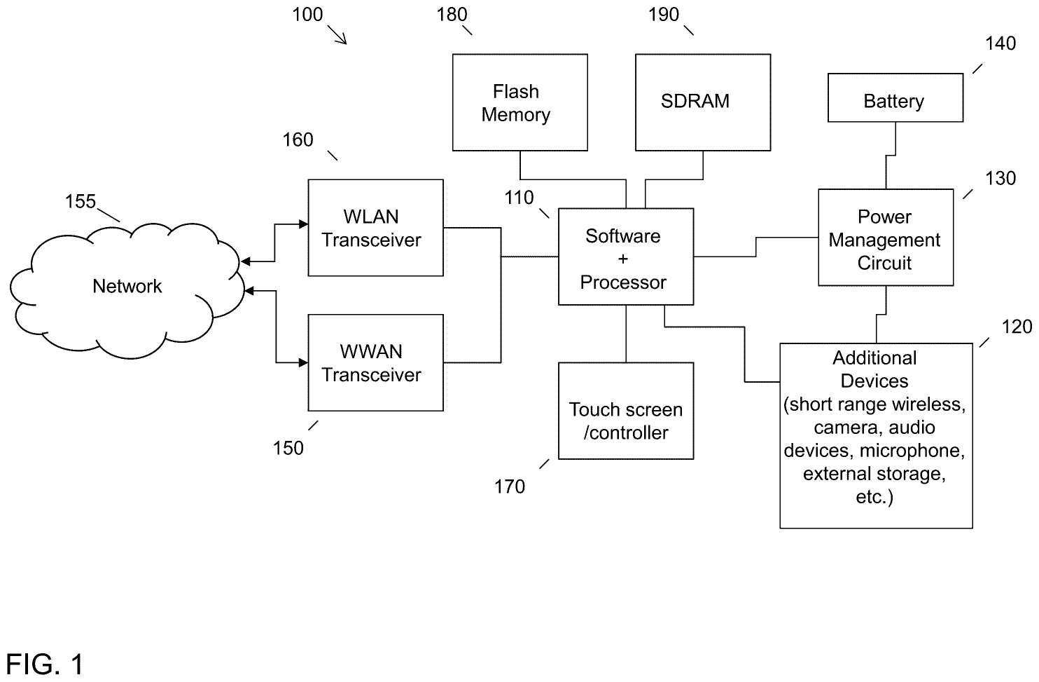

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

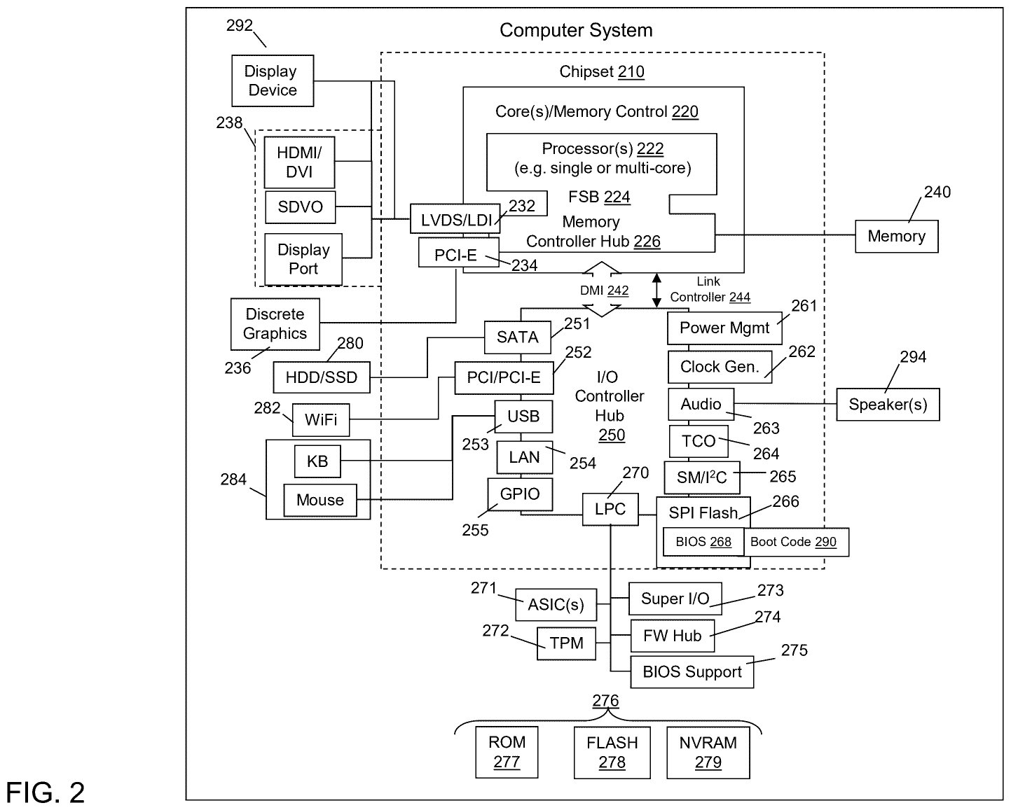

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used to communicate or interface with the described module and/or may be used as an attachment device for the described module. For example, the circuitry outlined in FIG. 1 may be implemented in a tablet or smart phone embodiment, whereas the circuitry outlined in FIG. 2 may be implemented in a personal computer embodiment.

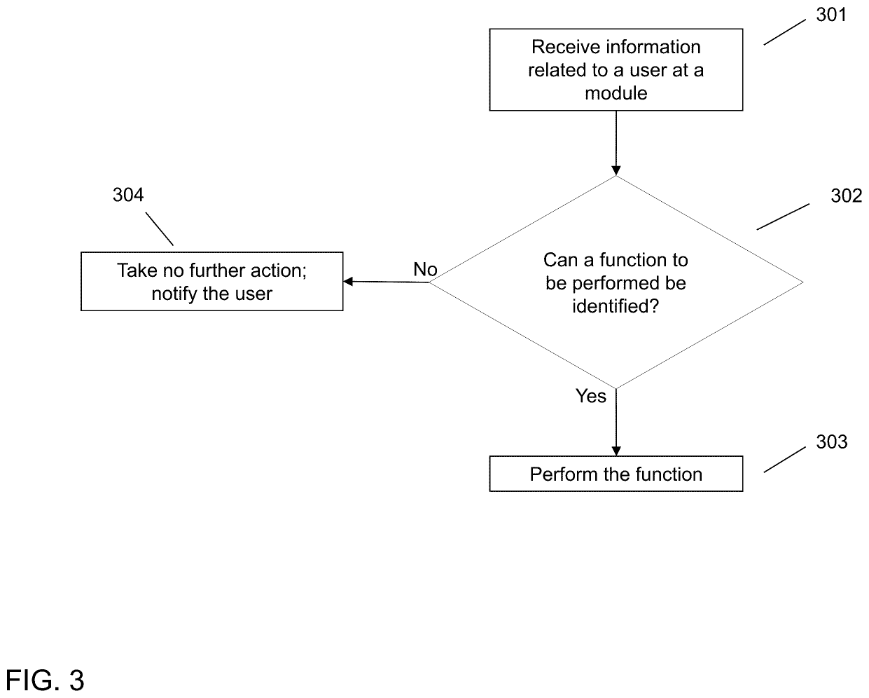

FIG. 3 illustrates an example method for performing functions utilizing a device companion module having an artificial intelligence system based upon information received by the module and related to a user. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to transfer refined queries to a different query response system. Additionally, the artificial intelligence (AI) companion device and system includes modules and features that are unique to the described system.

The AI companion device and system may be utilized by a user to capture information regarding a user and a user environment and to perform functions utilizing an artificial intelligence system. Thus, the AI companion device and system may be activated in order to receive inputs and capture information and also be activated in order to perform functions. Additionally, the AI companion device and system may be activated in order to communicate and interface with other devices. Activation of the AI companion device and system may be a manual activation of the AI companion device and system and/or an automatic activation of the AI companion device and system.

Manual activation of the system may include a user opening an application associated with the AI companion device and system, the user accessing the module associated with the AI companion device and system, the user pressing or providing an activation input on the module or a device or accessory associated with the module, the user providing an input to an information handling device associated with or connected to the module, and/or the user otherwise providing input to the AI companion device and system or associated device. The automatic activation of the AI companion device and system may be based upon the detection of a trigger event indicating that the system should be activated. Example trigger events include a user changing position that would indicate the AI companion device and system should start capturing information and inputs, a user performing an action that would indicate the system should capture inputs or provide outputs, trigger events that are set by the user, activation of software or an application utilizing the AI companion device and system, and/or the like.

It should be noted that the AI companion device and system may default to an activated state and may only be deactivated or turned-off up receiving an indication to do so. In other words, the AI companion device and system may be always on unless an instruction has been received that would indicate it should be turned off. The AI companion device and system may then act like a traditional device that is normally on after initially being turned on until an event occurs that indicates the device should be turned off, for example, a low battery state, an input to turn the device off, or other state or input that would indicate the device should be turned off or deactivated.

Additionally, the AI companion device and system may also have different states that may increase or decrease functions of the device and system in order to conserve battery life, conserve processing resources, increase processing capabilities, increase communication capabilities, and/or the like. For example, upon a low battery state, the system may reduce functions to conserve battery power. As another example, if the device cannot detect an ability to communicate with other devices, the system may at least temporarily turn off the communication mechanism. As a final, non-limiting example, if the device cannot detect the user is within a predetermined threshold proximity to the device, the device may enter a low power state. The functions or inputs that control these settings can be set by a user, set via default settings, can be learned over time, and/or the like.

The AI companion device and system may be made of multiple systems or modules that communicate together to make up the AI companion device and system or may be a single system. The AI companion device and system may be a standalone system, may be accessible through other computing devices, and/or a combination thereof. For example, the AI companion device and system may be a standalone system that can be accessed by a user and/or may be or provide an application that is accessible by a user on another computing device. The AI companion device and system may be accessible using any type of computing device, for example, personal computer, laptop computer, smartphone, tablet, smartwatch, head-mounted display, smart television or other smart appliance, augmented reality device, virtual reality device, any wearable accessor to enable computer vision, and/or the like.

Thus, the AI companion device and system may be accessible locally from the device itself or may be accessible locally using a computing device to which the AI companion device and system attached and/or may be accessible remotely through another computing device. For example, the AI companion device and system may be accessed by a user using a device that communicates with the AI companion device and system to receive additional inputs or information related to the user, to configure the device, access and modify user profiles, and/or the like. However, one or more parts of the AI companion device and system may be located and operate on a different information handling device as compared to the device being utilized by the user to perform the described steps.

The artificial intelligence system of the AI companion device and system can be provided as a service to other entities or companies. In other words, the AI companion device and system could be stored on a server or network of a company and the system could receive inputs and information, utilize the AI system of the providing entity to identify functions to perform, and then provide instructions for performing the functions. Additionally, the providing entity could create and keep AI systems that are unique to different users and use the corresponding AI system in identifying the functions to perform. The other entities would then pay for the creation and storage of the AI system or other use of the AI companion device and system. Additionally, a providing entity could create and sell the modules, accessories, and/or any other devices associated with the AI companion device and system.

The AI companion device and system may have an associated graphical user interface. This graphical user interface may be different than the display that is located on one side of the module, which will be referred to as the module display for ease of readability. The graphical user interface may be one that is provided when a user or other entity is attempting to configure the module or system, attempting to access information utilized by the module or system, and/or the like. The graphical user interface may be provided on a display or monitor, which may or may not be associated with the AI companion device and system. In other words, the AI companion device and system may have a dedicated display or monitor or may be accessible using any display or monitor. In either case, the AI companion device and system may provide instructions to generate and display the graphical user interface on the display device being used to access the AI companion device and system. The graphical user interface may also be updated and managed based upon instructions provided by the AI companion device and system. In other words, the AI companion device and system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the AI companion device and system. For example, the AI companion device and system may utilize a user profile, historical information, crowd-sourced information, and/or the like, to assist in refining the AI system to make it more personalized, identify what functions to be performed based upon particular inputs or information, identify how to perform the functions including what devices should be provided instructions for performing a function, and/or the like. The graphical user interface may allow for creation of or access to these profiles, historical information, crowd-sourced information, and/or the like, by allowing a user to input information regarding user preferences, functions to be performed, devices with which the module can interface, information needed to communicate with other devices, and/or the like. As will be discussed in more detail, the use of user provided information is not the only way that the profile and/or historical information can be created. The AI companion device and system can then utilize these inputs to create the profile(s), store the historical information, identify what functions to perform, identify how to perform a function, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, information of functions, information of crowd-sourced or historical information, and/or the like. It should be noted that the information to be used by the AI companion device and system and information provided by the AI companion device and system can be different for different applications, different computing systems, different users, and/or the like. Thus, the information corresponding to inputs or outputs of the AI companion device and system are not always the same. However, the AI companion device and system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The AI companion device and system may utilize one or more artificial intelligence models to identify a function to be performed based on inputs and information received by the system. Artificial intelligence models can also be used to populate information within the user profile or other information stored and accessible by the system. Artificial intelligence models could be designed to analyze inputs and information, identify functions to be performed, identify what devices should be used to perform a function, or any other steps within the described system. Artificial intelligence models may also be used for steps within a step. For example, a model could be utilized to analyze inputs that are received from one or more sensors to identify information that has been received by the module, analyze information to identify functions, identify devices that could perform a particular function, identify what device should be used to perform a function, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the AI companion device and system or may be a model that is created from scratch. Since the AI companion device and system is used in conjunction with identifying and performing functions based upon inputs, some models that may be utilized by the system are image analysis models, audio analysis models, other analysis models, entity identification models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The AI companion device and system may include different components for carrying out different functions of the system, including different steps to be performed. These components may be software components or hardware components. One software component includes the user profile that stores information related to the user and user preferences. The user profile may be unique to a user and may assist in determining how the system should respond to inputs and information received at the module. The user profile may identify different sensors that the module or system is allowed to access, different devices with which the module or system is allowed to communicate and interact, preferred devices for performing certain functions, capabilities of devices, functions that the user wants the module or system to perform, and/or the like. The system can also store historical information within the user profile, for example, information related to past inputs and related functions and devices that performed the functions.

Since the module may have a display screen located on one side of the module, the user profile may identify what information or types of information should be displayed on the display screen when the module is in different contexts. For example, the display screen may display notifications, a name tag, a mood of the user, preview of photos/video taken with the onboard camera, status or feedback of an AI voice assistant feature, agendas, functions of different applications available on an information handling device, and/or the like. Thus, the user profile may identify the situations or contexts in which the different information should be displayed. Similarly, the user profile may identify how the module should act in different contexts. For example, the module could act as a digital personal assistant, an image capture device that transmits images to a device, a translator, a narrator, and/or the like. Thus, the user profile may identify the contexts where the module performs each one of these purposes. It should be understood that the module and corresponding system is able to perform many different functions. Thus, the user profile may identify information related to different functions, different inputs, different contexts, and/or the like.

The user may manually input data into the profile or the information within the profile may be populated by the system as the system learns about the user over time. For example, the system may utilize an artificial intelligence model to learn about the user, make correlations between information received about the user and functions and performance thereof, and/or the like. This information can be populated within the user profile for use by the system during subsequent input and function performance cycles or sessions. The user profile may also include other information about the user that may seem to influence input and function performance cycles, for example, devices that are within proximity to the module, a location of a module with respect to other devices (e.g., attached to a device, within proximity of a device, etc.), an environment or context that the user is within, other users that are around the user, types of inputs and how they are analyzed and corresponding functions, a location of the user, and/or the like.

The system can also store other information, whether in a profile that might be related to an entity (e.g., the user, other users, devices, etc.), or in a different data storage location. How and where the information is stored may be dependent on different factors, such as the information being stored, what the information corresponds to, default storage settings, user selected settings, entity selected settings, and/or the like. For example, the system may store historical inputs and corresponding functions and any information related to that. As another example, the system may store contexts that are identified during an input and function performance cycle. As a final, non-limiting example, the system may store information that has been populated from crowd-sourced information. Other information can be stored and what information is stored may be based upon different factors.

Some hardware devices or components that may be utilized by the AI companion device and system include input devices that may be utilized to receive input from the user, for example, mechanical input modalities (e.g., keyboard, mouse, etc.), touch input devices, gesture input devices, electromyography input devices, audio input devices, image capture devices, and/or the like. Other hardware components may be utilized to provide output from the AI companion device and system. For example, the AI companion device and system may include speakers, displays or monitors, haptic output devices, audio output devices, and/or the like.

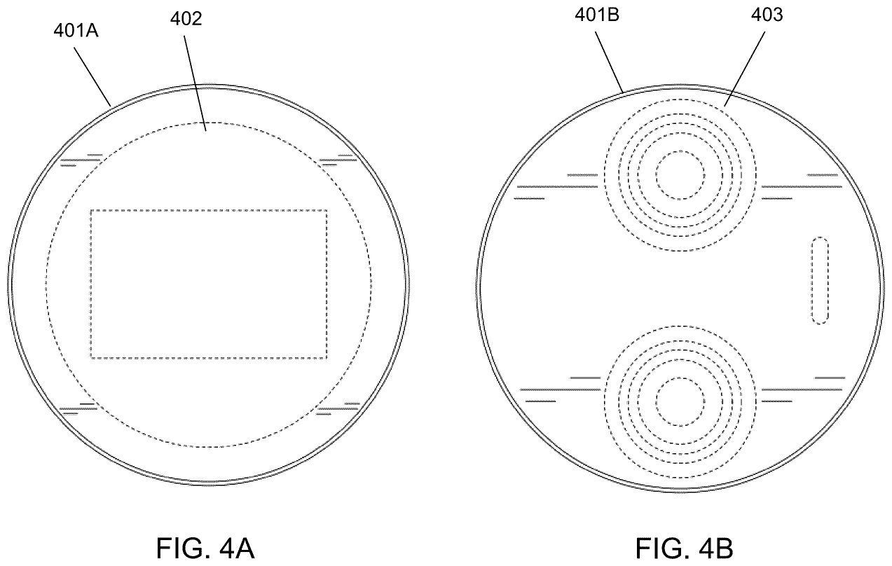

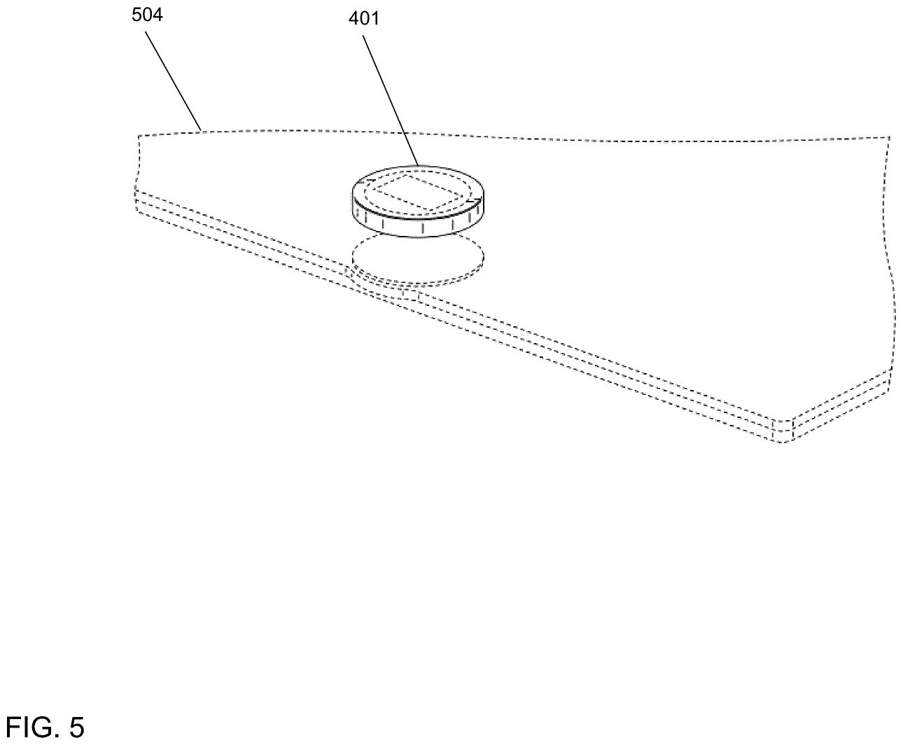

The AI companion device and system includes a module that is the base hardware component of the system. The module may have two sides that are opposite each other. This is best illustrated with FIG. 5 in combination with FIGS. 4A and 4B. On one side of the module, for example, 401A in FIG. 4A, a display screen 402 may be located. The display screen can be used to provide outputs to the user. The term “display screen” may include traditional display screens, touch screens, light-emitting diode lighting interfaces, segment displays, and/or any other type of visual output component or information interface. The information that is displayed on the display screen can vary based upon the objective of the module. The objective corresponds to what purpose the module is supposed to be performing at a particular time. Thus, the objective may be an overall purpose of the module at a particular time and may be based upon the context of the user, inputs and information being received by the module, and/or the like.

The objective may drive the functions that are being performed by the module at the time. Example types of objectives include, but are not limited to, a translator, a digital personal assistant, a narrator, a nametag, a mood reflector, an extension of an information handling device, a smart home or smart room hub, a speaker, a transcriber, a clock, a user status indicator, and/or the like. The module is able to perform many different functions and objectives. Accordingly, these are merely example objectives and other objectives are contemplated and possible. Additionally, the functions and objectives of the module may vary based upon a location of the module with respect to an information handling device or other device. For example, if the module is attached to a device it may perform certain functions or fulfill certain objectives, but if the module is not attached to a device is may perform different functions or fulfill different objectives. As another example, if the module is within a particular proximity to a certain device, it may perform different functions or fulfill different objectives as compared to when it is not within proximity to that device.

Information that may be displayed on the display screen could include notifications, user identification information, functions that are associated with an active application on a device that is connected to the module, emoticons or emojis, user-selected or default graphics or displays, displays associated with particular applications, and/or the like. For example, a user may be utilizing the module as an extension of an information handling device. On the device the user may be utilizing a presentation application. Thus, the display of the module may include shortcuts to different functions of that presentation application, for example, an “advance slide” icon, an “insert slide” icon, an icon that causes the module to read the text on a particular slide, and/or the like. As another example, the user may be utilizing the module as a digital personal assistant or accessing the AI voice assistant. Thus, the display of the module may provide notifications when an email has been received, provide reminders of calendar appointments, display information allowing the user to make a phone call, and/or the like. As another example, the user may be utilizing the module as a translator while the user is presenting a presentation to a group having different native speakers. The display may display the name of the presenter and the module may then interface with earbuds or other audio output devices to provide a translation of questions or comments that are being received from someone speaking in a different language than the presenter.

As another example, the user may be utilizing the module as an image capture device that transmits the captured images to a device. Thus, the display may show an image of what the user is capturing with the image capture device of the module. In other words, the display may provide information similar to a display of a digital camera. As a final, non-limiting example, the user may be utilizing the module as a user status indicator. Thus, the display may provide information related to the user and a level of focus of the user. For example, the display may display a “do-not-disturb” indicator when the user should not be disturbed or when the module or device perceives the user is at peak productivity. As another example, the display may display an “in-a-meeting” indicator when the user is in a meeting based off the user profile schedule or use of meeting software. As a final, non-limiting example, the display may display an “available” indicator when it would be acceptable to approach the user. Similarly, the display could display a mood of the user that can therefore indicate a status of the user. As should be understood, the display could display any number of different displays based upon the objective of the module.

On one side of the module, for example, 401B in FIG. 4B, at least one image capture device 403 may be located. The image capture device can be utilized to capture any image information including, but not limited to, still images, video, infrared images, three-dimensional images, heat signature images, and/or the like. The image capture device may include multiple lenses, as illustrated in FIG. 4B, in order to capture high resolution images and also to capture depth information along with image information. The image capture device may also include functions such as auto focus, wide-angle image/video capture capabilities, shutter speed adjustments, different camera modes, and/or the like. This may be particularly helpful when the module is being used in an augmented or virtual reality function. The depth information can be utilized to construct a three-dimensional image, for example, using light detection and ranging (LiDAR) technology, and/or the like. Alternatively, or additionally, each of the lens may be associated with a different type of image capture device or image sensor, for example, a traditional camera, an infrared image capture device, a heat signature image capture sensor, and/or the like. The image capture device side could also include other components for an image capture device, for example, a flash, an auto focus component, and/or the like.

As previously mentioned, the image capture device could be utilized to capture images and transmit the images to another device. The image capture device can also be used to obtain input for the module so that the module can identify and perform a function. Thus, in this case, the captured images may not be transmitted to a device for storage, but may instead be utilized by the artificial intelligence system. The image capture device could also capture video and transmit it to an application of the device for use by the application. For example, if the user is participating in a video conference, the module could capture the video that is transmitted to the other participants within the video conference in real-time, later as meeting notes or minutes, and/or the like. In other words, the module could be used to transmit information in real-time and/or could use captured information to perform a function at a later time. The image capture device can also be used for capturing gesture inputs provided by the user to the module. Other reasons for capturing images or input with the image capture device are contemplated and possible.

The display and image capture device could be located on opposing sides or may be located on the same side. In the case of opposing sides, one side of the module may have the display screen and the other side of the module could have the image capture device. However, the image capture device and display screen may also be located on the same side of the module. In this case, the image capture device components may be located behind the display screen using camera under display technology, so that the image capture device components do not interfere with user interaction with the display screen. Additionally, or alternatively, the image capture device components could be located in a bezel or on a perimeter of the display of the module so the camera components would not be located under the display. The image capture device and display configuration may also be a combination of camera under display technology and/or the image capture device components being located within a bezel or other non-display area.

Additionally, or alternatively, both sides may include an image capture device with one of the sides also including the display screen. For example, one side may appear like that illustrated in FIG. 4B. The other side may appear like that illustrated in FIG. 4A but also including image capture device components behind the display screen. In this case, the image capture device components on the display screen side may be smaller and not as powerful as those on the image capture device side so as to interfere less with the display screen.

Other configurations are contemplated and possible. For example, the image capture device may be located on half of one side with other components or devices located on the other half of the same side. Different splits of sides are contemplated and possible. The module may also include other components or devices located on one or both sides, for example, audio input devices, audio output devices, input mechanisms (e.g., sensors, buttons, touch sensors, etc.), connection ports, and/or the like. The components or devices may also be located around a perimeter or side of the module. Thus, the module could not only be used to transmit instructions to another device to control inputs or outputs (e.g., speaker volume of the other device, transmit audio input to the device, send instructions to the device to start a particular application on the device, send instructions to manipulate functions of the device, etc.), but could itself perform some of the functions. For example, the module could act as a camera, a microphone, a speaker, and/or the like. In this case, the module may transmit instructions to the device to transfer the function to the module so as to reduce redundancy of the function. For example, if the module is being treated as a speaker and microphone, the module may transfer the speaker and microphone from the device speaker and microphone to the module so as to prevent feedback and echoing between the device and the module.

The module may be of a size that facilitates attachment to or integration into devices of any size and attachment to or integration into a wearable accessory. On the other hand, the module may be large enough that the display is viewable and useful to the user. For example, the module may have a diameter of an inch and half. This is merely an illustrative example as many different sizes can be used that would meet the desired criteria. As illustrated in the figures, the module may have a circular shape. While a circular or curved shape is a useful shape for providing the deactivation turning or rotation of the module, the module may be of any shape, for example, an oval, square, rectangle, triangle, irregular shape, and/or the like. Even if a circular shape is used, the module may have a different method for deactivating the module. Thus, even if the module has a circular shape, turning the module may not result in the deactivation of the module. Alternatively, rotation of the module perimeter dial or module itself may have a different function, for example, sending particular instructions to a device, controlling an interface of the device that the module is attached to (either integrally or removably attached to) performing a pairing action, adjusting a characteristic of the camera or display of the module, and/or the like. Additionally, different amounts of rotation may have different functions. For example, a full 360° rotation may deactivate the module, while a half rotation dims the brightness of the module, and/or the like. The functions performed in response to the rotation may be user selectable.

As an example, the user may rotate the module perimeter dial (also referred to as a bezel) or the module itself to provide input or make a selection. When the module is attached to the information handling device, or for the module that is integral to the information handling device, the user can use the bezel or turn the module to launch and select different user interfaces on the device or module. As another example, the user can use the bezel or turn the module to make a selection from an application that is active on the display, to choose an application as the active application, to choose the function of the display screen of the module, to choose an objective for the module, and/or the like.

Additionally, the module may include other input modalities. For example, the module may include a “button-press” where the whole module could be pressed or squeezed to perform an action, the module may include a touch screen for the display screen, the perimeter or sides of the module may include buttons, touch sensors, or other input mechanisms, the bezel of the module may include input mechanisms, the module could include a camera on each side of the module to capture gestures as inputs, and/or the like.

The module can also include other components that can assist in performing the various functions, for example, a communication mechanism that allows the module to communicate with other devices (e.g., devices within an Internet of Things (IoT) setting, other devices of the user, etc.), a battery or other power source, a charging mechanism to charge the device (e.g., an induction wireless charging mechanism, pogo pins, a charging connector, etc.), a processor, at least one memory device which may store code or instructions for performing different functions, and/or the like. The memory device may include program code for an artificial intelligence system, as described in more detail herein.

The module can act as a companion to not only the user but also devices of the user. Accordingly, the module can not only communicate with a device, but can also attach to or be integral to a device. FIG. 5 illustrates a side view of the module 401 and how it might be attached to an information handling device 504. In this example, the device includes a particular location where the module 401 is located. In the case that the module is attachable, or removable, from a device, the attachment of the module to the device may include any type of attachment mechanism, for example, fastening mechanisms (e.g., hook and loop fasteners, pins and holes, clips, etc.), magnets, and/or the like. The module may include attachment mechanisms that allow the module to be attached to the device with either of the two sides of the module facing outwards. In other words, assuming a display screen on one side and an image capture device on the other side, the module could be attached to the device so that either the display screen side or the image capture device side could be facing outwards.

In the case that the module is integral to the device, the module may be manufactured with the device. In this case, the sides of the module may be configured based upon the fact that the module is integral to a device. For example, a display may not completely cover one side if that is the side that is integral to the device. Additionally, or alternatively, depending on how the module is integrated into the device, the two sides could be as previously described. For example, if the device is integrated into a top edge of the device, then the layout of the components on the two sides would not need to be modified. The layout of the components on the two sides may also be modified based upon which side will be outward facing and which side will be inward facing. Additionally, based upon the integration of the module into the device, the objective of the module may vary as compared to a removable/attachable module. More specifically, the potential objectives of the integral module may be reduced as compared to the potential objectives of a removable modules.

One example objective of an integral module may be as an extension of a device that provides outputs to a user even when the device may be closed or in a sleep state. For example, if the device is a laptop device or other device with a cover, when the cover is closed the device may be inactive. However, the module may be located on the device so that it can detect motion or light within the environment using the image capture device and/or display. The module could then provide relevant information from the device based upon a time of day, factors that the device identifies as relevant or useful to the user, and/or the like. The user could also interact with the AI of the module even if the device is in a low power state or is closed. In other words, the module can remain active even if the device is not active. The module could provide outputs to the user. Thus, the integral module could still perform a digital personal assistant objective, it may just have less features as compared to the removable module. Alternatively, the integral module could perform a device extension objective, even when the device is closed or in a lower power state.

As another example, when the device is in a presentation mode with the world-facing camera of the device visible to the user as a presenter, the module could be used to provide information related to the presentation. For example, the display side of the integral module could display different real-time information regarding the presentation, for example, remaining presentation time, an indication of meeting participants asking questions, an indication of a number of participants, any detected errors with the presentation (e.g., muted microphone, disabled video capture device, etc.) a preview of the presenter to see what is in frame for the world-facing camera, and/or the like. Similarly, the module could provide real-time information related to other applications that may be active on the device. Other objectives for an integral module are contemplated and possible, for example, some previously mentioned objectives may still be possible using the integral module. There are merely illustrative examples.

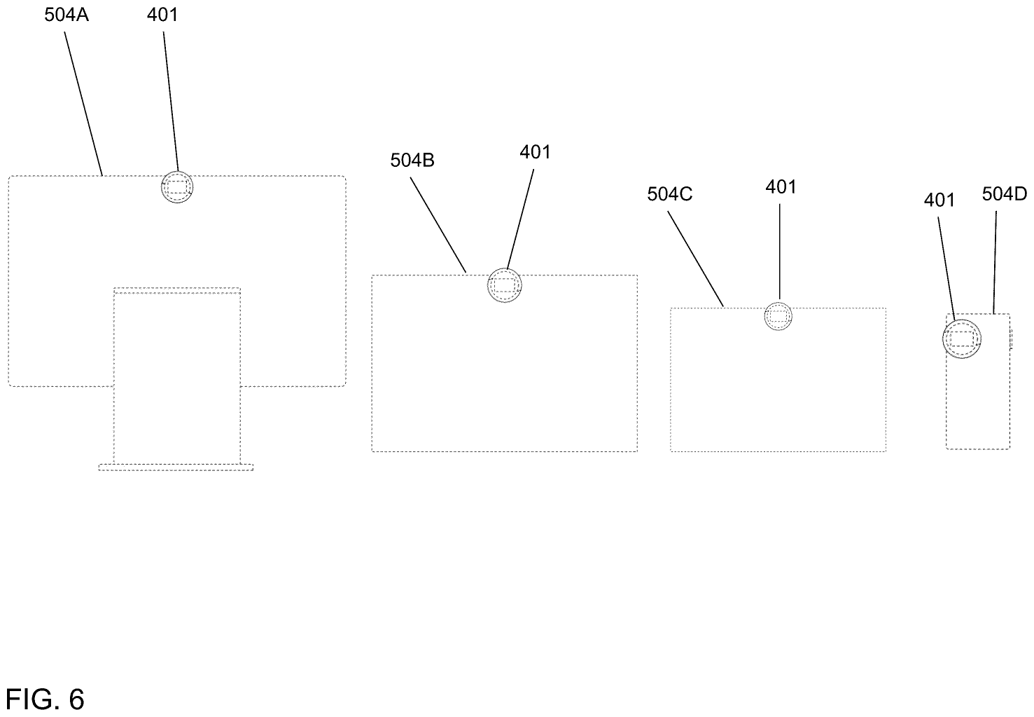

FIG. 6 illustrates other devices that the module 401 could be attached or integral to. In these examples, the module 401 could be attached to a stand alone display 504A, a laptop 504B, a tablet 504C, a smart phone 504D, and/or the like. It should be understood that the module could be attached to any information handling device. Additionally, while the module is illustrated as being attached at the upper center of the devices, the attachment point could be any location, for example, towards a bottom or side of the device, on a top, bottom, or side edge of the device, on the front or back of the device, and/or the like. Thus, the module may overhang an edge of the device, connect to an edge of the device, be located on the front of the device, and/or the like. In other words, the location of the module with respect to the device can vary and be configured by a user based upon the objective of the module or preferences of the user. When attached to the device, the device may assist in charging the module, may provide a direct connection between the device and module, and/or the like.

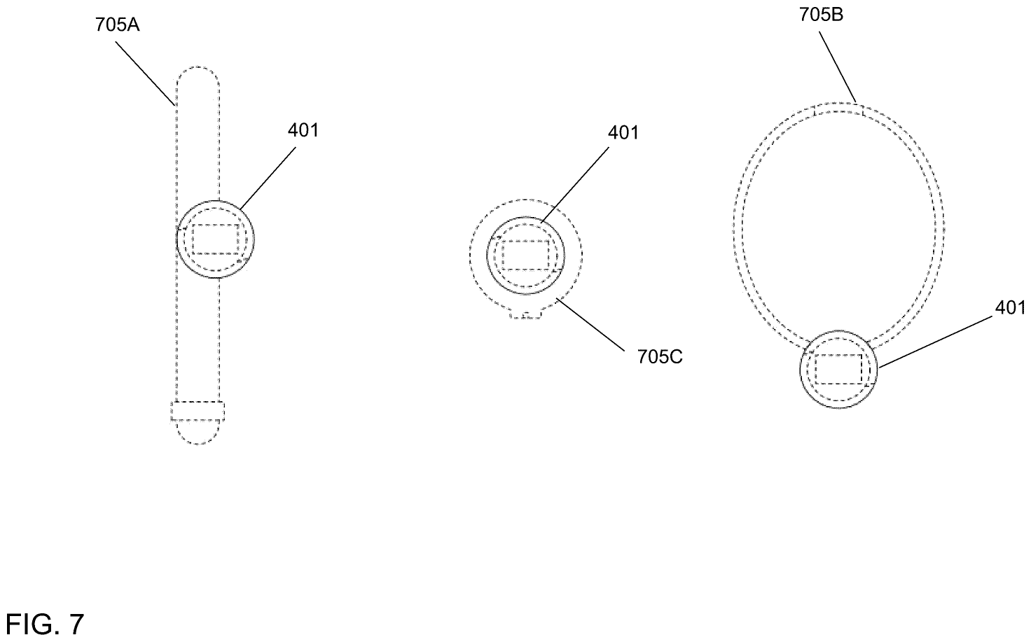

The module can also be attached to a wearable accessory, for example, as illustrated in FIG. 7. FIG. 7 illustrates the module 401 attached to a watch band 705A, thereby allowing the user to wear the module as a watch, a necklace 705B, thereby allowing the user to wear the module as a necklace, and a pendant or pin 705C, thereby allowing the user to wear the module as a pendant or pin. In this case, the module may either be place in a pendant or pin setting or module that may include a fastener that allows the fastening of the pendant or pin module to clothing. For example, the fastener may include a pin, magnets that have a corresponding portion to hold to the clothing, or other fastening devices. Alternatively, or additionally, the module itself may be connected to the clothing using a fastening device. The module may also be included in other wearable accessories, for example, a belt buckle, a buckle on a shoe, an armband, a headband, and/or the like.

The module can also interface with other components of the user. Components may not have the same processing capabilities as a device. For example, components may include glasses, earbuds, keyboards, input devices, and/or the like. The module can also be placed within other modules that are part of the AI companion device and system. For example, the system may include a pod module that can house the module. The pod module may include additional components that can provide the module with additional or more powerful capabilities. The pod module may include charging capabilities to charge the module, may include communication mechanisms that allow for communication to other devices, may be connected to other devices and may allow control of those devices while the module is attached to the pod module, and/or the like. For example, the pod module may act as a hub device for communication with devices that are capable of communication with other devices. In other words, in this example, the module while attached to the hub module may act as a smart device hub to connect to and communicate with smart devices, for example, in a home environment.

Thus, to perform the described functions, at 301, the module and system may receive information related to a user and a context of the user. The context of the user may identify not only an environment or location of a user, but also what is happening within the environment or location. Thus, the context may identify other users within the environment, objects within the environment, a proximity of users to the module or other users, actions being performed by the user or other users, other devices within the environments, and/or the like. Identifying the context may be performed using a rules engine, an artificial intelligence model, user provided inputs, and/or the like. The context may also identify the location of the module with respect to an information handling device, other devices, other modules of the system, and/or the like.

Thus, the information may include any information or inputs that can be used to identify the context of the user and module and also any information or inputs that can be processable by the module to perform a function for the user. Thus, inputs not only include contextual information but also includes any inputs that are directed to the module or devices connected to or in communication with the module.

From the information, the system attempts to determine if a function to be performed can be identified at 302. To identify a function, the system may utilize an artificial intelligence system. Thus, the information and inputs related to the context and other information captured may be provided as input to the artificial intelligence model and system. The artificial intelligence model and system may be trained to be unique to the user. Thus, the functions that are identified may be unique to the user of the module. In other words, the objectives and functions identified by the module and performed by the module may be unique to the user based upon the artificial intelligence model and system learning about the user over time. Functions may be easily identified by the module, for example, due to the user providing specific input to perform a particular function.

Alternatively, the system may have to infer a function based upon the information and inputs received at the module and provided as input to the artificial intelligence system. It should be noted that explicit instructions or inputs may also have an inferred portion. For example, the user may provide the input “it is cold in here, change the temperature.” While the user provided an explicit instruction to change the temperature, the user did not indicate what temperature to change the temperature to. Thus, the system must infer the temperature based upon the input context of it being cold and also based upon previously identified information known by the system. Inferred functions may become more accurate over time with the learning by the artificial intelligence model and system.

Additionally, instead of specifically performing a function, the AI model and system may simply obtain inputs regarding the context to learn more about the user so that functions can be more easily inferred at a later time. In other words, not all information and inputs that are received at the module may be immediately used to perform a discernable function. Rather, some of the information and inputs may simply be used to train the AI model and system. Thus, the module and system may be continuously tracking and monitoring a user and their environments.

If a function to be performed cannot be identified at 302, the system may take no further action and/or notify the user at 304. If, on the other hand, a function to be performed can be identified at 302, the function may be performed at 303. Performing the function may include the module itself performing the function, for example, providing an output at the module using an output device of the module, or may include sending instructions to another device. Thus, performing a function may include providing instructions to another device regarding actions that should be performed by the another device or instructions to be provided to yet another device from the first device. Functions may include changing characteristics of the device (e.g., changing a volume, changing a brightness on a display, etc.), manipulating an application on the device (e.g., advancing a slide, opening an application, etc.), providing instructions to perform a function associated with a device or object (e.g., closing window shades, changing the temperature of a thermostat, etc.), making a phone call, taking a note, reading out a calendar schedule, reading a text message, providing a narration of an environment, providing directions to the user, and/or the like. In other words, the functions can include any possible action that can be performed by a device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A device, the device comprising:
a module having two sides, wherein the two sides are opposite each other, the module comprising:
at least one display screen located on at least one of the two sides of the module;
at least one image capture device located on at least one of the two sides of the module;
at least one processor; and
at least one memory device storing program code for an artificial intelligence system;
wherein the module communicates with an information handling device; and
wherein the module performs functions utilizing the at least one processor and the artificial intelligence system.

2. The device of claim 1, wherein the module is attachable to at least one of: the information handling device, a wearable accessory, and a pod module.

3. The device of claim 1, wherein the module is integral to the information handling device.

4. The device of claim 1, wherein the at least one image capture device is located on a same of the two sides of the module as the at least one display screen.

5. The device of claim 1, wherein the module comprises a communication mechanism, wherein the module communicates, using the communication mechanism, with Internet of Things devices.

6. The device of claim 1, wherein the module further comprises an audio input device and an audio output device.

7. The device of claim 1, wherein at least one of the functions comprises functions related to a digital personal assistant objective and being unique to a user of the module.

8. The device of claim 1, wherein the module further comprises a charging mechanism.

9. The device of claim 1, wherein the communication with the information handling device comprises instructions for manipulating functions of the information handling device.

10. The device of claim 1, wherein the functions performed by the module vary based upon a location of the module with respect to at least one of the information handling device and another device.

11. The device of claim 1, wherein the module captures information related to a user and a context of the user and wherein the information is provided as input to the artificial intelligence system.

12. A system, the system comprising:
an information handling device;
a module having two sides, wherein the two sides are opposite each other, the module comprising:
at least one display screen located on at least one of the two sides of the module;
at least one image capture device located on at least one of the two sides of the module;
at least one processor; and
at least one memory device storing program code for an artificial intelligence system;
wherein the module communicates with the information handling device; and
wherein the module performs functions utilizing the at least one processor and the artificial intelligence system.

13. The system of claim 12, wherein the module is attachable to at least one of: the information handling device, a wearable accessory, and a pod module.

14. The system of claim 12, wherein the at least one image capture device is located on a same of the two sides of the module as the at least one display screen.

15. The system of claim 12, wherein the module comprises a communication mechanism, wherein the module communicates, using the communication mechanism, with Internet of Things devices.

16. The system of claim 12, wherein the module further comprises an audio input device and an audio output device.

17. The system of claim 12, wherein at least one of the functions comprises functions related to a digital personal assistant objective and being unique to a user of the module.

18. The system of claim 12, wherein the communication with the information handling device comprises instructions for manipulating functions of the information handling device.

19. The system of claim 12, wherein the functions performed by the module vary based upon a location of the module with respect to at least one of the information handling device and another device.

20. A method, the method comprising:
receiving, at a module having two sides, information related to a user and a context of the user, wherein the two sides are opposite each other, wherein the module comprises at least one display screen located on at least one of the two sides of the module and at least one image capture device located on at least one of the two sides of the module, wherein the module communicates with an information handling device;
identifying a function to be performed to assist the user by analyzing, using an artificial intelligence system of the module, the information; and
performing, using the module, the function.
